(19) United States
(12) Patent Application Publication
(10) Pub. No.: US 2016/0224339 A1
(43) Pub. Date: Aug. 4, 2016

(54) PROGRAM CONVERTING SYSTEM AND PROGRAM CONVERTING METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: ZI ZHANG, Shenzhen (CN); WEI XU, Shenzhen (CN); MING-SHAN CAO, Shenzhen (CN); KUEI-YANG LIN, Tu-Cheng (TW)

(21) Appl. No.: 14/700,945

(22) Filed: Apr. 30, 2015

(30) Foreign Application Priority Data
Feb. 4, 2015 (CN) 201510057693.2

(51) Int. Cl. G06F 9/44

(52) U.S. Cl. CPC G06F 8/76

(57) ABSTRACT

A program converting system is provided. The system is running on a comparator. The program converting system includes a program importing module, a program converting module, a characteristic parameters fetching module and a storage module. The program importing module is used to import a program data package containing a first measurement program and characteristic parameters of at least one sample. The program converting module is used to convert the first measurement program to a second measurement program suitable for a comparator. The characteristic parameters fetching module is used to fetch the characteristic parameters from the program data package. The storage module is used to store the second measurement program and the characteristic parameter in a storage unit of the comparator. A method for program converting is also provided.

### FIELD

The subject matter herein generally relates to program converting systems and program converting methods.

### BACKGROUND

DMIS (Dimensional Measurement Interface Specification) is a communication standard in the automation industry used for testing data, and the program language used is PC-DMIS (Personal Computer-Dimensional Measuring Interface Specification). Comparator is contact scanning equipment, which needs the actual characteristic parameters of the sample to refer as a reference. When the comparator is used with a device installed with the DMIS, the measurement procedures should be written in the device first, the sample should be measured second to get the actual characteristic parameters of the sample by the device, and then the measurement procedures should be written in the comparator according to the actual characteristic parameters of the sample, which is inconvenient.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a program converting system.

FIG. 2 is a block diagram of an embodiment of an operating environment of the program converting system shown in FIG. 1.

FIG. 3 is a flowchart of an embodiment of a program converting method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

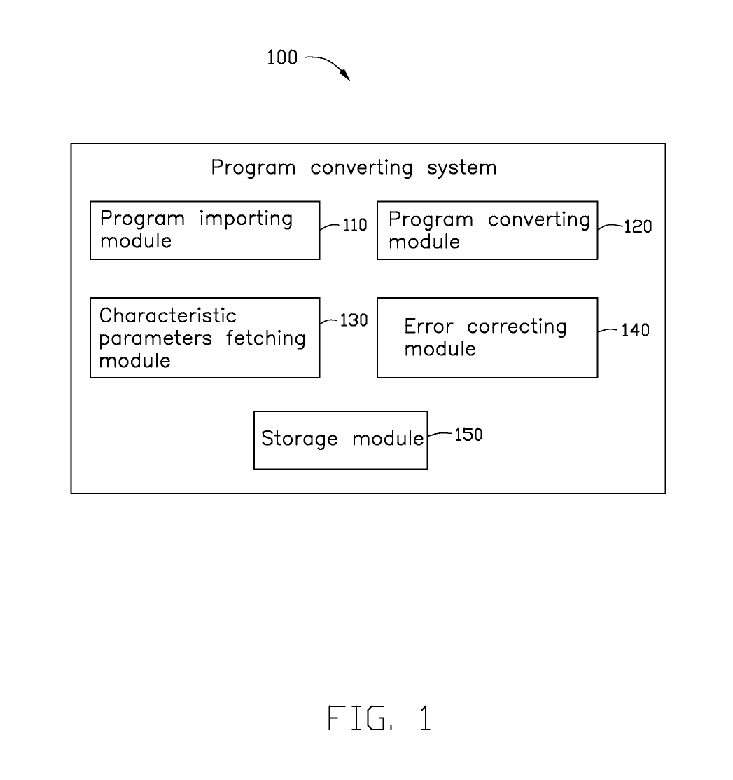

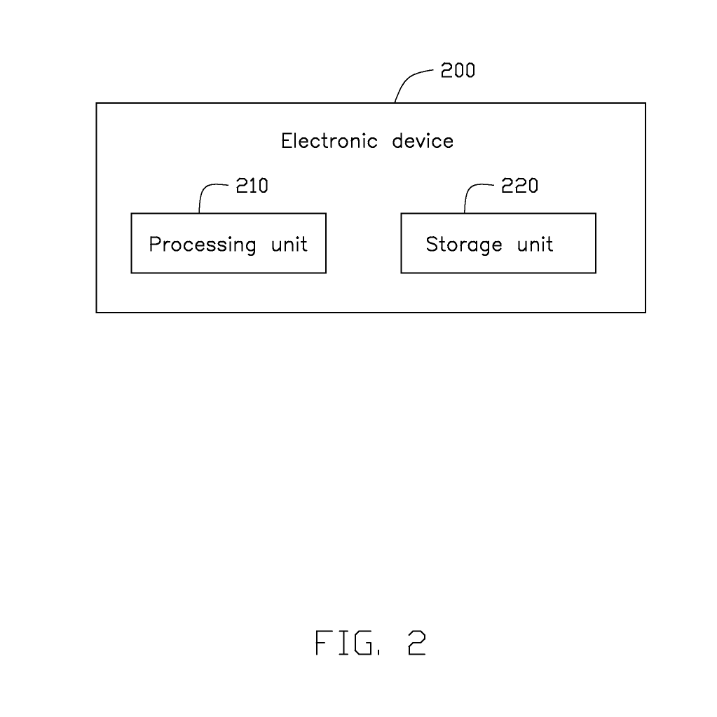

FIG. 1 shows a program converting system 100. The program converting system 100 can be run on but not limited to a comparator 200 which is shown on FIG. 2.

The comparator 200 can include a processing unit 210 and a storage unit 220.

In at least one embodiment, the processing unit 210 can be a central processing unit, a digital signal processor, or a single chip, for example.

In at least one embodiment, the storage unit 220 can be an internal storage system, such as a flash memory, a random access memory (RAM) for temporary storage of information, and/or a read-memory (ROM) for permanent storage of information.

In at least one embodiment, the storage unit 220 can also be a storage system, such as a hard disk, a storage card, or a data storage medium. The storage unit 220 can include volatile and/or non-volatile storage devices.

In at least one embodiment, the storage unit 220 can include two or more storage devices such that one storage device is a memory and the other storage device is a hard drive. Additionally, the storage unit 220 can be respectively located either entirely or partially external relative to the comparator 200.

The program converting system 100 can include a number of modules, and the number of modules can include a program importing module 110, a program converting module 120, a characteristic parameters fetching module 130, an error correcting module 140 and a storage module 150. The number of modules can be stored in the storage unit 220, and further applied on the processing unit 210.

The program importing module 110 can be used to import a program data package. The program data package can include a first measurement program and characteristic parameters of at least one sample. In this embodiment, the program language of the first measurement program is PC-DMIS (Personal Computer-Dimensional Measuring Interface Specification).

The program converting module 120 can be used to convert the first measurement program to a second measurement program which is suitable for the comparator 200. In this embodiment, the document format of the second measurement program is DMI (Dimensional Measuring Interface).

The characteristic parameters fetching module 130 can be used to fetch the characteristic parameters of the at least one sample from the program data package. In this embodiment, the characteristic parameters fetching module 130 can further convert the document format of the characteristic parameters to CAL (Calibration).

The error correcting module 140 can be used to compare the first measurement program with the second measurement program, and determine whether the second measurement program is corresponding to the first measurement program, and further correct the errors in the second measurement program when determined that the second measurement program is not corresponding to the first measurement program.

The storage module 150 can be used to control the storage unit 220 to store the second measurement program and the characteristic parameters of the at least one sample. In this embodiment, the storage module 150 can be used to control the storage unit 220 to store the second measurement program of which the document format is DMI and the characteristic parameters of the at least one sample of which the document format is CAL.

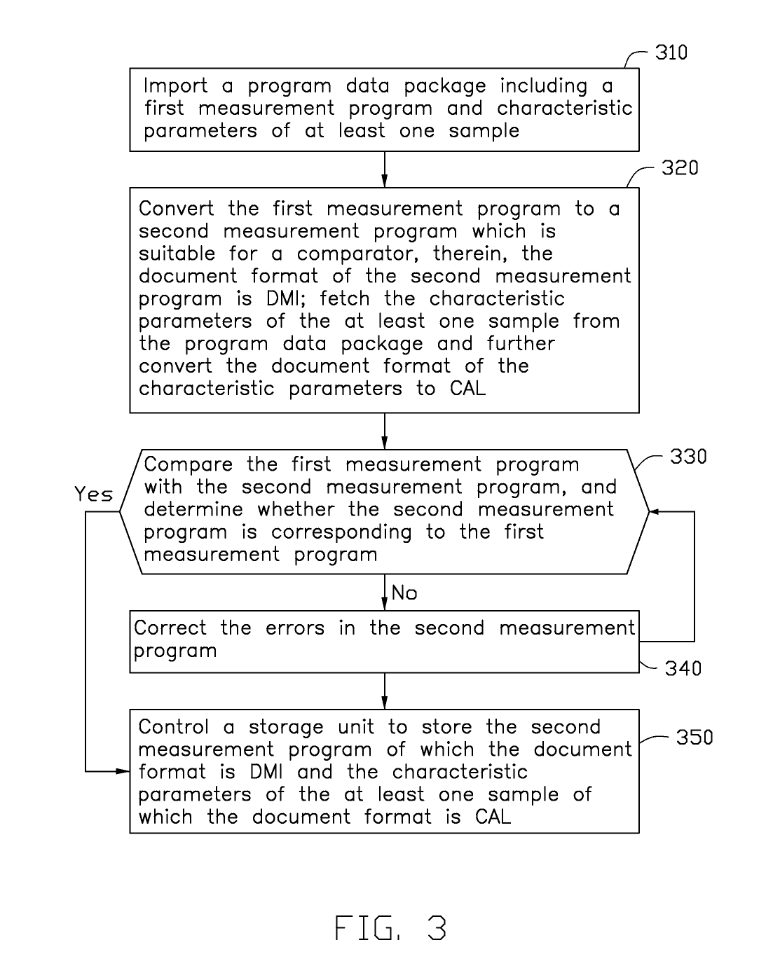

FIG. 3 illustrates a flowchart of a method for program converting. The method for program converting is provided by way of example, as there are a variety of ways to carry out the method. The control method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 310.

At block 310, a program importing module imports a program data package, and the program data package includes a first measurement program and characteristic parameters of at least one sample. Therein, the program language of the first measurement program is PC-DMIS.

At block 320, a program converting module converts the first measurement program to a second measurement program which is suitable for a comparator, therein, the document format of the second measurement program is DMI; a characteristic parameters fetching module fetches the characteristic parameters of the at least one sample from the program data package and further converts the document format of the characteristic parameters to CAL.

At block 330, an error correcting module compares the first measurement program with the second measurement program, and determines whether the second measurement program is corresponding to the first measurement program, if yes, the process goes to block 340, otherwise, the process goes to block 350.

At block 340, the error correcting module corrects the errors in the second measurement program, and the process goes to block 330.

At block 350, a storage module controls a storage unit to store the second measurement program of which the document format is DMI and the characteristic parameters of the at least one sample of which the document format is CAL.

The first measurement program can be converted to the second measurement program suitable for the comparator, which brings convenience and reduce the default rate.

In at least one embodiment, if the first measurement program can be converted to the second measurement program precisely, the error correcting module 140 can be thus omitted.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A program converting system, running on a comparator, the program converting system comprising:
a plurality of processing units; and
a plurality of modules coupled to the plurality of processing units, each of the plurality of modules including instructions to be executed by one or more of the plurality of processing units, the plurality of modules including:
a program importing module configured to import a program data package including a first measurement program and characteristic parameters of at least one sample;
a program converting module configured to convert the first measurement program to a second measurement program which is suitable for the comparator;
a characteristic parameters fetching module configured to fetch the characteristic parameters of the at least one sample; and
a storage module configured to control a storage unit of the comparator to store the second measurement program and the characteristic parameters.

2. The program converting system of claim 1, wherein a program language of the first measurement program is PC-DMIS.

3. The program converting system of claim 1, wherein a document format of the second measurement program is DMI.

4. The program converting system of claim 1, wherein the characteristic parameters fetching module is further configured to convert a document format of the characteristic parameters to CAL.

5. The program converting system of claim 1, further comprising:
an error correcting module configured to compare the first measurement program with the second measurement program, and determine whether the second measurement program is corresponding to the first measurement program, and further correct errors in the second measurement program when determined that the second measurement program is not corresponding to the first measurement program.

6. A program converting method, running on a comparator, the program converting method comprising:
importing a program data package including a first measurement program and characteristic parameters of at least one sample;
converting the first measurement program to a second measurement program which is suitable for the comparator and fetching the characteristic parameters from the program data package; and
storing the second measurement program and the characteristic parameters.

7. The program converting method of claim 6, wherein a program language of the first measurement program is PC-DMIS.

8. The program converting method of claim 6, wherein a document format of the second measurement program is DMI.

9. The program converting method of claim 6, further comprising:
converting a document format of the characteristic parameters to CAL.

10. The program converting method of claim 6, further comprising:
comparing the first measurement program with the second measurement program, and determining whether the second measurement program is corresponding to the first measurement program; and
correcting errors in the second measurement program when determined that the second measurement program is not corresponding to the first measurement program.
